(19) United States
(12) Patent Application Publication
(10) Pub. No.: US 2026/0282083 A1
(43) Pub. Date: Sep. 17, 2026

(54) FLEXIBLE CHANNEL ACCESS

(71) Applicant: Telefonaktiebolaget LM Ericsson (publ), Stockholm (SE)

(72) Inventors: Leif WILHELMSSON, Lund (SE); Abhishek AMBEDE, Huddinge (SE); Charlie PETTERSSON, Solna (SE); Rocco DI TARANTO, Lund (SE); Sebastian MAX, Cologne (DE)

(21) Appl. No.: 19/469,105

(22) PCT Filed: Apr. 4, 2023
(86) PCT No.: PCT/EP2023/058879

§ 371 Date: Sep. 25, 2025

(51) Int. Cl. H04W 74/0808

(52) U.S. Cl. CPC H04W 74/0808

(57) ABSTRACT

A method, network node and wireless device (WD) for flexible channel access are disclosed. According to one aspect, a method in a WD includes performing a wideband listen-before-talk (LBT) process over a wideband LBT bandwidth, the wideband LBT bandwidth being wider than a maximum channel bandwidth intended for a transmission. The method also includes determining a presence of at least one idle channel based at least in part on the wideband LBT process.

### TECHNICAL FIELD

The present disclosure relates to wireless communications, and in particular, to flexible channel access.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs 22. The 3GPP is may also develop standards for Sixth Generation (6G) wireless communication networks.

In addition to these standards, the Institute of Electrical and Electronic Engineers (IEEE) has developed and continues to develop standards for other types of wireless communication networks, including Wireless Local Area Networks (WLANs), also known as Wi-Fi networks, and Bluetooth networks. WLANs include wireless communication between access points (APs) and WDs 22. Such IEEE standards include IEEE 802.11a/b/g/n/ac/ax and IEEE 802.15.

Consider a planned wireless system, where a network operator deploys and configures multiple network nodes to provide good coverage over a certain area using a limited total available bandwidth. One quite common option is to split the bandwidth into multiple frequency channels. Then network nodes that are relatively close to one another, and potentially could interfere with one another, are configured to use different frequency channels. This is commonly referred to as frequency reuse and when a frequency reuse of N is applied it means that the total bandwidth is divided into N non-overlapping channels and that these N channels are allocated by the network operator to the different network nodes in a way that minimize the experienced interference (for that N). Examples of commonly used values of N is 3, 4, 7 and 21. The choice of reuse factor is a trade-off between having a large bandwidth (small N) and suffering from very little co-channel interference (large N). Denote the coverage area of a network node and the corresponding frequency channel a “cell”.

If the wireless system is operating in license-exempt bands, like being the case for IEEE 802.11, wideband wireless communication systems typically operate using the listen before talk (LBT) mechanism, also referred to as carrier sense multiple access with collision avoidance (CSMA/CA). The working procedure of LBT is as the name suggests. Before a transmission may be initiated, a transmitter listens on the wireless medium to determine whether a desired channel is occupied (“busy”) or unoccupied (“idle”) by using an appropriate carrier sensing mechanism. If the channel is found to be “idle,” the transmission may be initiated with a channel access mechanism that involves a random backoff procedure. On the contrary, if the channel is found to be “busy,” the transmitter must defer from transmission and essentially keep sensing the channel until it becomes idle. The communication is challenging especially in the presence of interference which may occur, for example, due to collisions when other transmitters gain access to the channel at the same time or when there are other systems (wideband or narrowband) operating in partially or completely overlapping channels. It could also happen that the full desired channel bandwidth is not idle for a transmitter to use, due to certain portions of the desired channel bandwidth being busy.

The fact that LBT is used may be an advantage in that one may use a small frequency reuse and still not suffer from interference. However, the reason for this is that if two cells are using the same channel and are within range of one another (i.e., a device in one cell will detect a transmission by a device in another cell and therefore defer from transmitting), the channel will effectively be shared in time between the two cells. If the amount of traffic is low, this may still be quite efficient since most of the time there will not be any traffic in the other cell and therefore the channel will be found to be idle. However, for high traffic scenarios it is typically preferred to employ a relatively large reuse factor and consequently assign relatively small bandwidths to the different cells. The reason for this is that the risk of collision increases and also that the variations in delay for accessing a channel may be rather significant. The same strategy applies to scenarios that support low latency operation: even if the load is not high, the risk of finding the channel occupied by a neighboring cell and thus delivering the packet too late forbids a low reuse factor with a large bandwidth per cell.

The trend today is that wireless systems like those based on IEEE 802.11 technology and operating in license-exempt bands are moving towards using even larger channel bandwidths.

IEEE 802.11ax which is the latest generation on the market, uses up to 160 MHz channels, while, IEEE 802.11be, which is expected to be available within a year or two, will support up to 320 MHz channels. Even if in some geographical regions the frequency band at 6 GHz is 1.2 GHz wide, it is obvious that only a very small frequency reuse factor may be used. For operation in the 5 GHz band where much less band is available, a single cell may make use of a large part of the available spectrum.

Another trend for IEEE 802.11 is that there is an increased demand for supporting applications that demand low latency and high reliability. This is a new paradigm for systems operating in unlicensed bands, which traditionally has had a focus on providing high data rate, but with limited demands on latency and reliability. Note that latency and reliability should be considered jointly and not as two separate features. The challenge is to achieve reliable communication with low latency. If the latency is not considered, reliability is often trivially achieved by allowing the packet to be retransmitted as many times as needed until it is reliably received.

Returning to the cellular concept and the notion of frequency reuse, there is an inherent limitation of this concept when it comes to efficient use of the spectrum. Suppose that a relatively large frequency reuse factor is selected so that the channel bandwidth of a cell is small. Now, if one would consider the activities on all channels at one specific time, likely a large part of the channels would typically be unused. This means that at a specific moment in time, a given cell could likely use a larger bandwidth, but it is of course not clear exactly what additional channel could be used as this will vary from one time to another.

Today, it is possible to perform LBT over a relatively large bandwidth, say 160 MHz, and then perform this LBT in such a way that the 160 MHz is effectively considered as eight 20 MHz channels so that if some of the 20 MHz channels are found to be busy, the transmitter may puncture the 160 MHz signal such that it will only occupy the 20 MHz channels that have been found to be idle. In practice, however, there are some issues with this approach. The reason being that the transmitter typically would prepare for a 160 MHz transmission, and if the entire 160 MHz is not available the punctured packet may not be robust enough to be reliably received. Although one in principle could prepare packets for different bandwidths and use the proper packet based on the outcome of the LBT, this is typically considered too complex to be feasible.

A fundamental problem with LBT is the fact that the LBT determines the channel conditions at the transmitter, whereas no explicit information about the channel conditions at the receiver is obtained. Basically, the LBT may be viewed as primarily being intended for not generating interference to other ongoing transmissions, but not to determine whether transmitter's own transmission will be (severely) interfered and thereby fail with high likelihood. One approach solves the problem by essentially also requesting the receiver to perform LBT and inform the transmitter about what channels are feasible for transmission. An exemplary working procedure over an 80 MHz channel could be as follows: the AP performs LBT over 80 MHz and finds the entire 80 MHz to be idle. Normally, the AP would then transmit an 80 MHz signal to the intended STA. However, according to some known methods, the AP sends a request to the STA to further perform LBT over the 80 MHz channel. Then the STA reports back which part of the 80 MHz are suitable for transmission also from the receiver point of view. Since the AP has found all 80 MHz idle, all 80 MHz are suitable from the transmitter point of view.

However, if then the STA finds that only 60 MHz has good receiver conditions because 20 MHz of the total 80 MHz are interfered by a narrowband 20 MHz transmission, this information is reported back to the AP, and the AP will then transmit a packet that is only 60 MHz wide.

This approach to effectively involve the receiver in the determination of finding a suitable channel may be seen as the best approach, although it comes with a small amount of overhead. The approach focuses on the performance in a single cell, and the impact of interference from other cells is essentially taken into account by also performing the LBT at the receiver end. However a limitation with this approach is in that the bandwidth used for this single cell is not adapted based on the interference situation in the surroundings, at least not on a time-scale similar to the time durations between different LBT events.

### Spatial Reuse in IEEE 802.11

The IEEE 802.11ax technology includes features to address increased spatial reuse of resources. Specifically, the IEEE 802.11ax technology supports two different spatial reuse schemes: OBSS PD-based (Overlapping Basic Service Set (BSS) Preamble Detection (PD)) spatial reuse and PSR (Parametrized Spatial reuse).

In OBSS PD-based spatial reuse, the STAs controls their transmit power in a trade-off fashion: The STA is allowed to ignore the inter-BSS protocol data unit (PDU) during its LBT procedure in exchange for reducing its own transmit power. The amount of reduction is proportional to the received signal strength of the inter-BSS PDU. Thus, the STA (herein also referred to as a WD) is likely forced to adapt the MCS to a more robust rate. If the inter-BSS PDU is received with a low power, the used transmit power may be higher, allowing for higher MCS but likely less opportunities of spatial reuse.

PSR operation is specialized for the case of inter-BSS HE (High Efficiency) TB-PPDU transmissions: The STA is allowed to ignore inter-BSS PPDUs if it detects a HE trigger-based physical layer protocol data unit (TB-PPDU) or a trigger frame (TF) with a field denoted as “SPATIAL REUSE” being set and if it controls the transmit power during the PPDU duration. The control of the transmit power is done based on an indication of the maximum allowed interference power that the potential victim may accept. This interference power level is signaled in either the TF or the HE TB-PPDU. The use of PSR may be controlled through the use of a field denoted as “PSR_DISALLOW” in the HE-SIG-A field. By setting the HE-SIG-A field, another AP or STA may thus decide whether or not PSR is allowed.

Both OBSS PD-based spatial reuse and PSR have in common that there is always a “primary” and a “secondary” STA of the transmission opportunity: The primary STA starts the transmission and indicates that a reuse is permitted by setting the bits in the preamble or in the TF. Only after having received this information, the secondary STA may re-start its channel access, using the adapted transmission parameters. Furthermore, both schemes require a fast adaptation of the transmit power and of the transmit duration (which is limited to the primary transmit opportunity duration) by the secondary STA.

During the development of the IEEE 802.11be amendment, multi-access point (AP) coordination was initially one of the candidate features being discussed but was down prioritized during the task group. Herein, an AP may be referred to as a network node. One of the most discussed forms of cooperation was coordinated spatial reuse (CSR). CSR has several benefits over the spatial reuse supported by the IEEE 802.11ax technology, such as increased system throughput due to more tight coordination. CSR is however controlled by the AP and thus requires some preparation before an uplink (UL) CSR transmission may begin. Such preparation may for example include that the involved APs acquire the buffer status reports from the associated STAs and determine which STAs should be served in the transmit opportunity (TXOP). On the other hand, a more autonomous spatial reuse, as supported by the IEEE 802.11ax technology, is typically simpler since it is the STA that determines whether or not to allow transmission, which may for example provide latency benefits.

In a system having more than one cell, what limits the performance when operating in license-exempt bands is typically coexistence between cells rather than the link performance within a cell. The standard approach to deal with coexistence is to divide the total available bandwidth into a number of channels and assign a subset of these to each cell. This leads to a situation where the overall system spectrum efficiency is quite poor even if the momentaneous spectrum efficiency within an isolated call may be very high. In addition, when the system is expected to support applications that require low latency and high reliability this may be expected to degrade the spectrum efficiency even further due to that resources to a larger degree must be reserved, one way or another. The most straight forward way to achieve this reservation is probably to use a large frequency reuse factor in order to ensure that a specific cell will not have to defer because a transmission in another cell is detected. Thus, there is an inherent problem in trying to support high spectrum efficiency and at the same time obtain high reliability and low latency.

Approaches like OBSS PD-based SR and PSR enable an opportunistic spatial reuse and thus a better dynamic frequency sharing; however, they target networks with an unplanned, “chaotic” structure where opportunities for them arise due to overlapping cells that use the same frequency channel.

### SUMMARY

Some embodiments advantageously provide methods, network node and wireless devices (WDs) for flexible channel access.

This disclosure addresses the problem of frequency reuse in an LBT-based multi-cell wireless system by adopting a flexible approach. Specifically, the different cells are not limited to use a small set of specific channels, but may select to use channels from a much larger set. Depending on whether there is a requirement to guarantee high reliability and low latency, the number of channels that may be used may be limited to be less than the number of channels that are evaluated as available for transmission. Interestingly, the fact that a first cell is able to use a large bandwidth enables the first cell to finalize its transmission in a shorter time and thus will also benefit the other cells as the first cell may then no longer contend for the spectrum at a slightly later moment in time.

In the present disclosure, a fundamentally different approach is taken to enhance the performance in a system using LBT. Some embodiments include methods to improve overall system performance, taking into account the instantaneous interference conditions over as large a bandwidth as possible, and in this way select a proper part of the spectrum to be used. The approach is different from known methods in at least the following ways. First, LBT is only used at the transmitter side. This may be expected to be sub-optimal compared to known approaches. Second, in the known methods the transmitter performs LBT over a certain channel bandwidth that is intended to be used for the transmission. This would be possible provided that the LBT at the receiver side shows that the entire bandwidth intended for transmission is suitable for reception. In contrast, LBT according to the present disclosure is over a bandwidth that is (much) larger than what is intended to be used for the transmission. As an example, the LBT may be over 160 MHz even though only a 20 MHz transmission will be sent. By performing LBT over a much larger bandwidth than needed for the transmission, the probability of finding an idle channel will increase, leading to increased performance.

Some embodiments may also be combined with a more classical approach where cells are assigned sets of fixed channels. Such combination may be advantageous either when the total load is relatively high or when there are very strict requirements on latency and reliability.

Various ways to adjust the parameters that are used in some embodiments are disclosed.

Some embodiments, improve spectrum efficiency in a system using LBT. The gain is expected to increase for situations where the load is low or moderately high, and where there may be more demanding requirements on latency and reliability. Some embodiments provide a more efficient approach to support high reliability and low latency applications without having to significantly sacrificing the spectrum efficiency of the system.

According to one aspect, a method in a WD configured to communicate with a network node is provided. The method includes performing a wideband listen-before-talk, LBT, process over a wideband LBT bandwidth, the wideband LBT bandwidth being wider than a maximum channel bandwidth intended for a transmission. The method also includes determining a presence of at least one idle channel based at least in part on the wideband LBT process.

According to this aspect, in some embodiments, the wideband LBT bandwidth includes a plurality of channels and the wideband LBT process is performed over N channels of the plurality of channels, N being an integer greater than a maximum number of channels included in the maximum channel bandwidth intended for the transmission. In some embodiments, the method includes selecting an idle channel determined to be present for the transmission based at least in part on channel conditions of the idle channel. In some embodiments, the channel conditions of the idle channel include an estimated interference power of the idle channel. In some embodiments, the method includes receiving channel selection information and selecting an idle channel for the transmission based at least in part on the channel selection information. In some embodiments, the method includes transmitting channel feedback information to the network node, the channel feedback information being based at least in part on channel conditions at the WD. In some embodiments, the method includes selecting a packet to be transmitted on an idle channel based at least in part on a latency requirement of the packet and a number of idle channels determined to be present. In some embodiments, the method includes selecting a transmission channel bandwidth for the transmission based at least in part on a bandwidth of channels determined to be idle. In some embodiments, selecting the transmission channel bandwidth for the transmission includes selecting a different channel bandwidth for each of a plurality of packets to be transmitted. In some embodiments, the transmission channel bandwidth selected for a packet transmissions depends at least in part on a latency requirement.

According to another aspect, a WD configured to communicate with a network node is provided. The WD includes processing circuitry configured to: perform a wideband listen-before-talk, LBT, process over a wideband LBT bandwidth, the wideband LBT bandwidth being wider than a maximum channel bandwidth intended for a transmission; and determine a presence of at least one idle channel based at least in part on the wideband LBT process.

According to this aspect, in some embodiments, the wideband LBT bandwidth includes a plurality of channels and the wideband LBT process is performed over N channels of the plurality of channels, N being an integer greater than a maximum number of channels included in the maximum channel bandwidth intended for the transmission. In some embodiments, the processing circuitry is further configured to select an idle channel determined to be present for the transmission based at least in part on channel conditions of the idle channel. In some embodiments, the channel conditions of the idle channel include an estimated interference power of the idle channel. Some embodiments include a radio interface in communication with the processing circuitry and configured to receive channel selection information and selecting an idle channel for the transmission based at least in part on the channel selection information. In some embodiments, the radio interface is further configured to transmit channel feedback information to the network node, the channel feedback information being based at least in part on channel conditions at the WD. In some embodiments, the processing circuitry is further configured to select a packet to be transmitted on an idle channel based at least in part on a latency requirement of the packet and a number of idle channels determined to be present. In some embodiments, the processing circuitry is further configured to select a transmission channel bandwidth for the transmission based at least in part on a bandwidth of channels determined to be idle. In some embodiments, selecting the transmission channel bandwidth for the transmission includes selecting a different channel bandwidth for each of a plurality of packets to be transmitted. In some embodiments, the transmission channel bandwidth selected for a packet transmissions depends at least in part on a latency requirement.

According to yet another aspect, a method in a network node configured to communicate with a wireless device, WD, is provided. The method includes performing a wideband listen-before-talk, LBT, process over a wideband LBT bandwidth, the wideband LBT bandwidth being wider than a maximum channel bandwidth intended for a transmission. The method also includes determining a presence of at least one idle channel based at least in part on the wideband LBT process.

According to this aspect, in some embodiments, the method includes selecting an idle channel determined to be present for the transmission based at least in part on channel conditions of the idle channel. In some embodiments, the channel conditions of the idle channel include an estimated interference power of the idle channel. In some embodiments, the method includes transmitting to the WD on a dedicated channel an indication of a portion of an idle channel to be used for the transmission. In some embodiments, the method includes comprising receiving channel feedback information from the WD, the channel feedback information being based at least in part on channel conditions at the WD, and determining the portion of the idle channel based at least in part on the channel feedback information. In some embodiments, the dedicated channel is a narrowband channel used by at least one other network node that uses the wideband LBT bandwidth. In some embodiments, the method includes selecting a packet to be transmitted on an idle channel based at least in part on a latency requirement of the packet and a number of idle channels determined to be present. In some embodiments, the method includes selecting a channel bandwidth for the transmission based at least in part on a traffic load, selected channel bandwidth being inversely proportional to the traffic load. In some embodiments, the method includes selecting a transmission channel bandwidth for the transmission based at least in part on a bandwidth of channels determined to be idle. In some embodiments, selecting the transmission channel bandwidth for the transmission includes selecting a different channel bandwidth for each of a plurality of packets to be transmitted. In some embodiments, the transmission channel bandwidth selected for a packet transmissions depends at least in part on a latency requirement.

According to another aspect, a network node configured to communicate with a wireless device, WD, the network node comprising processing circuitry configured to: perform a wideband listen-before-talk, LBT, process over a wideband LBT bandwidth, the wideband LBT bandwidth being wider than a maximum channel bandwidth intended for a transmission; and determine a presence of at least one idle channel based at least in part on the wideband LBT process.

According to this aspect, in some embodiments, the processing circuitry is further configured to select an idle channel determined to be present for the transmission based at least in part on channel conditions of the idle channel. In some embodiments, the channel conditions of the idle channel include an estimated interference power of the idle channel. In some embodiments, a radio interface in communication with the processing circuitry is configured to transmit to the WD on a dedicated channel an indication of a portion of an idle channel to be used for the transmission. In some embodiments, the radio interface is further configured to receive channel feedback information from the WD, the channel feedback information being based at least in part on channel conditions at the WD, and wherein the processing circuitry is further configured to determine the portion of the idle channel based at least in part on the channel feedback information. In some embodiments, the dedicated channel is a narrowband channel used by at least one other network node that uses the wideband LBT bandwidth. In some embodiments, the processing circuitry is further configured to select a packet to be transmitted on an idle channel based at least in part on a latency requirement of the packet and a number of idle channels determined to be present. In some embodiments, the processing circuitry is further configured to select a channel bandwidth for the transmission based at least in part on a traffic load, selected channel bandwidth being inversely proportional to the traffic load. In some embodiments, the processing circuitry is further configured to select a transmission channel bandwidth for the transmission based at least in part on a bandwidth of channels determined to be idle. In some embodiments, selecting the transmission channel bandwidth for the transmission includes selecting a different channel bandwidth for each of a plurality of packets to be transmitted. In some embodiments, the transmission channel bandwidth selected for a packet transmissions depends at least in part on a latency requirement.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node for flexible channel access;

FIG. 8 is a flowchart of an exemplary process in a wireless device for flexible channel access;

FIG. 9 illustrates a first channel usage pattern;

FIG. 10 illustrates a second channel usage pattern;

FIG. 11 illustrates a third channel usage pattern; and

FIG. 12 illustrates a fourth channel usage pattern.

### DETAILED DESCRIPTION

Before describing in detail exemplary embodiments, it is noted that the embodiments reside primarily in combinations of apparatus components and processing steps related to flexible channel access. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of an access point (AP), base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) or non-AP STA are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, IEEE 802.11, IEEE 802.15, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide flexible channel access.

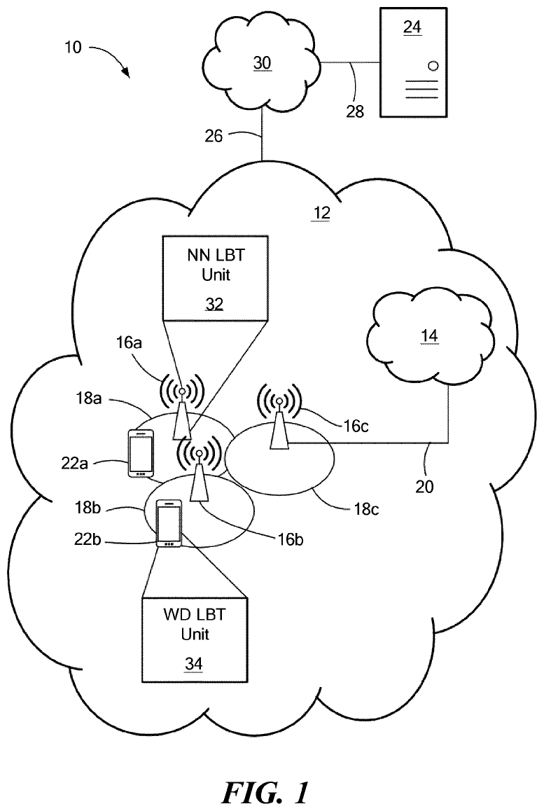

Referring now to the drawing figures, in which like elements are referred to by like reference numerals, there is shown in FIG. 1 a schematic diagram of a communication system 10, according to an embodiment, such as WLAN communication network, a Bluetooth communication network a 3GPP-type cellular network that may support standards such as LTE and/or NR (5G), which comprises an access network 12, such as a radio access network, and a core network 14. The access network 12 comprises a plurality of APs, hereinafter referred to as network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Coverage areas 18 are also referred to herein as “cells”. Each network node 16a, 16b, 16c is connectable to the core network 14 over a wired or wireless connection 20. A first non-AP STA, hereinafter referred to as a wireless device (WD) 22a, is located in coverage area 18a and configured to wirelessly connect to, or be paged by, the corresponding network node 16a. A second non-AP STA, WD 22b, in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR and/or that supports WLAN, Wi-Fi or Bluetooth, for example.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a network node (NN) LBT unit 32 which is configured to perform a wideband listen-before-talk, LBT, process over a wideband LBT bandwidth, the wideband LBT bandwidth being wider than a maximum channel bandwidth intended for a transmission. A wireless device 22 is configured to include a WD LBT unit 34 which is configured to perform a wideband listen-before-talk, LBT, process over a wideband LBT bandwidth, the wideband LBT bandwidth being wider than a maximum channel bandwidth intended for a transmission.

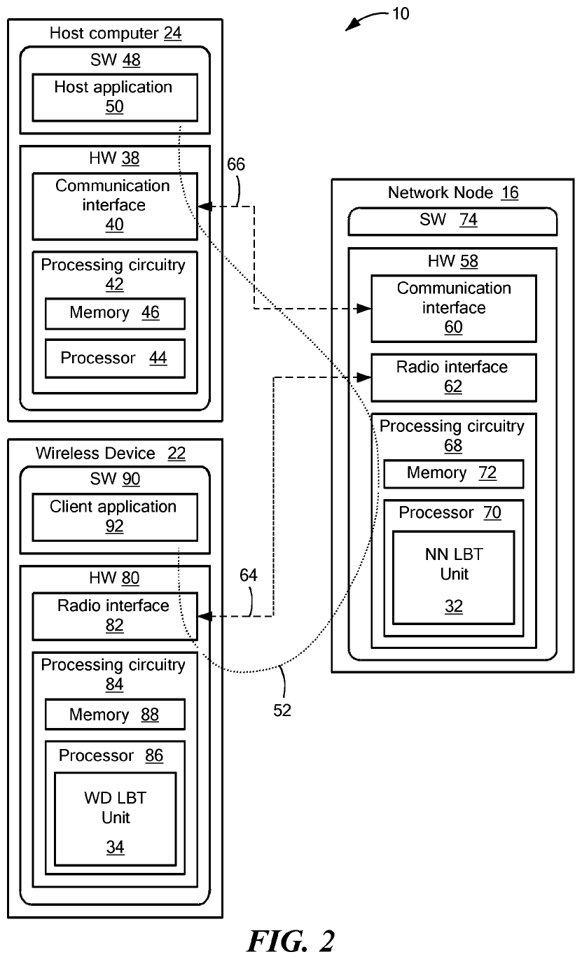

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a network node (NN) LBT unit 32 which is configured to perform a wideband listen-before-talk, LBT, process over a wideband LBT bandwidth, the wideband LBT bandwidth being wider than a maximum channel bandwidth intended for a transmission.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD LBT unit 34 which is configured to perform a wideband listen-before-talk, LBT, process over a wideband LBT bandwidth, the wideband LBT bandwidth being wider than a maximum channel bandwidth intended for a transmission.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc. ; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as NN LBT unit 32, and WD LBT unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

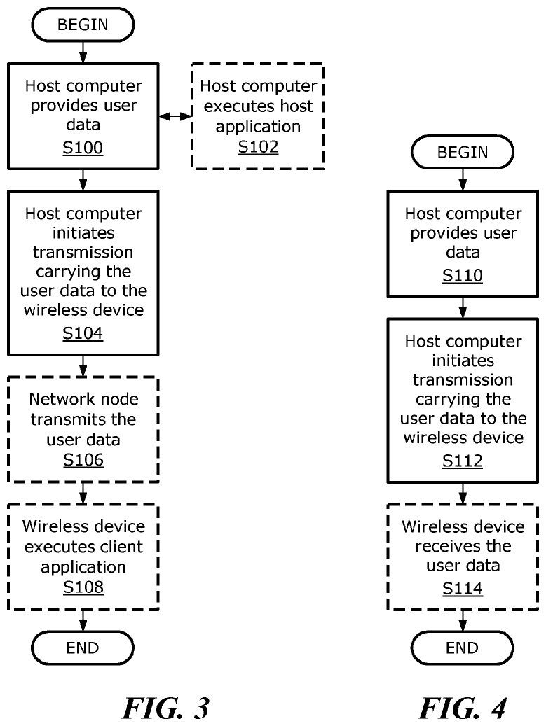

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

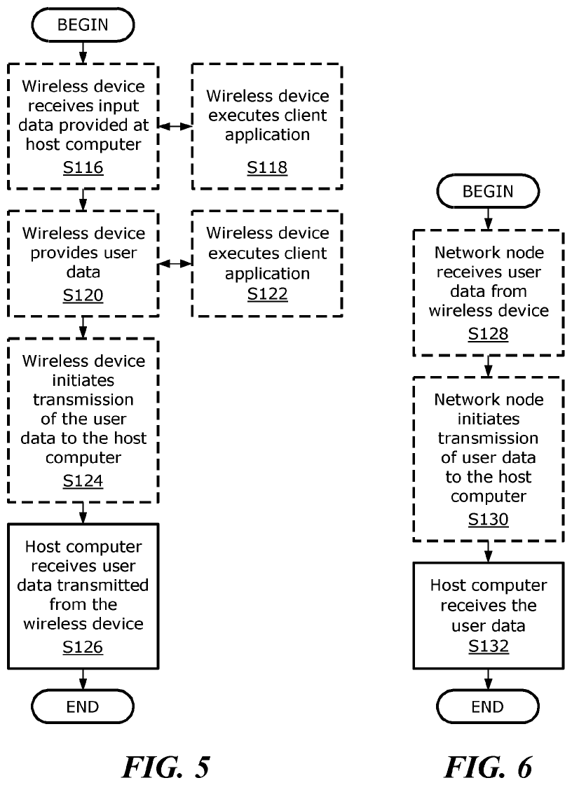

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

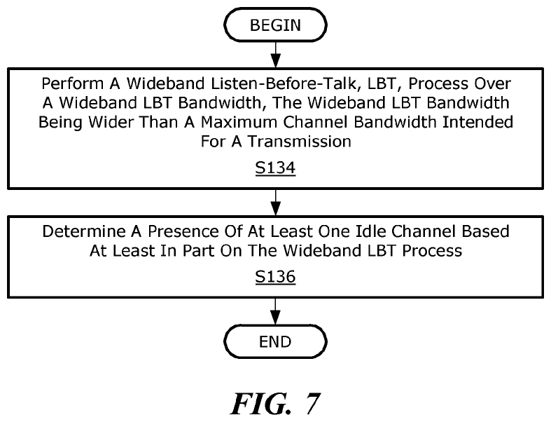

FIG. 7 is a flowchart of an exemplary process in a network node 16 for flexible channel access. One or more blocks described herein may be performed by one or more elements of network node 16 such as by one or more of processing circuitry 68 (including the NN LBT unit 32), processor 70, radio interface 62 and/or communication interface 60. Network node 16 such as via processing circuitry 68 and/or processor 70 and/or radio interface 62 and/or communication interface 60 is configured to perform a wideband listen-before-talk, LBT, process over a wideband LBT bandwidth, the wideband LBT bandwidth being wider than a maximum channel bandwidth intended for a transmission (Block S134). The method also includes determining a presence of at least one idle channel based at least in part on the wideband LBT process (Block S136).

According to this aspect, in some embodiments, the method includes selecting an idle channel determined to be present for the transmission based at least in part on channel conditions of the idle channel. In some embodiments, the channel conditions of the idle channel include an estimated interference power of the idle channel. In some embodiments, the method includes transmitting to the WD on a dedicated channel an indication of a portion of an idle channel to be used for the transmission. In some embodiments, the method includes comprising receiving channel feedback information from the WD, the channel feedback information being based at least in part on channel conditions at the WD, and determining the portion of the idle channel based at least in part on the channel feedback information. In some embodiments, the dedicated channel is a narrowband channel used by at least one other network node that uses the wideband LBT bandwidth. In some embodiments, the method includes selecting a packet to be transmitted on an idle channel based at least in part on a latency requirement of the packet and a number of idle channels determined to be present. In some embodiments, the method includes selecting a channel bandwidth for the transmission based at least in part on a traffic load, selected channel bandwidth being inversely proportional to the traffic load. In some embodiments, the method includes selecting a transmission channel bandwidth for the transmission based at least in part on a bandwidth of channels determined to be idle. In some embodiments, selecting the transmission channel bandwidth for the transmission includes selecting a different channel bandwidth for each of a plurality of packets to be transmitted. In some embodiments, the transmission channel bandwidth selected for a packet transmissions depends at least in part on a latency requirement.

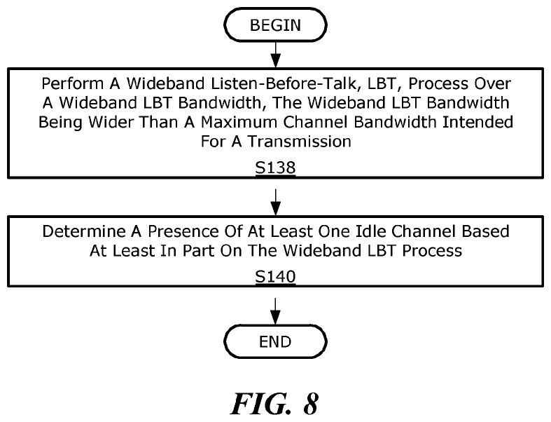

FIG. 8 is a flowchart of an exemplary process in a wireless device 22 according to some embodiments of the present disclosure. One or more blocks described herein may be performed by one or more elements of wireless device 22 such as by one or more of processing circuitry 84 (including the WD LBT unit 34), processor 86, radio interface 82 and/or communication interface 60. Wireless device 22 such as via processing circuitry 84 and/or processor 86 and/or radio interface 82 is configured to perform a wideband listen-before-talk, LBT, process over a wideband LBT bandwidth, the wideband LBT bandwidth being wider than a maximum channel bandwidth intended for a transmission (Block S138). The method also includes determining a presence of at least one idle channel based at least in part on the wideband LBT process (Block S140).

According to this aspect, in some embodiments, the wideband LBT bandwidth includes a plurality of channels and the wideband LBT process is performed over N channels of the plurality of channels, N being an integer greater than a maximum number of channels included in the maximum channel bandwidth intended for the transmission. In some embodiments, the method includes selecting an idle channel determined to be present for the transmission based at least in part on channel conditions of the idle channel. In some embodiments, the channel conditions of the idle channel include an estimated interference power of the idle channel. In some embodiments, the method includes receiving channel selection information and selecting an idle channel for the transmission based at least in part on the channel selection information. In some embodiments, the method includes transmitting channel feedback information to the network node 16, the channel feedback information being based at least in part on channel conditions at the WD. In some embodiments, the method includes selecting a packet to be transmitted on an idle channel based at least in part on a latency requirement of the packet and a number of idle channels determined to be present. In some embodiments, the method includes selecting a transmission channel bandwidth for the transmission based at least in part on a bandwidth of channels determined to be idle. In some embodiments, selecting the transmission channel bandwidth for the transmission includes selecting a different channel bandwidth for each of a plurality of packets to be transmitted. In some embodiments, the transmission channel bandwidth selected for a packet transmissions depends at least in part on a latency requirement.

Having described the general process flow of arrangements of the disclosure and having provided examples of hardware and software arrangements for implementing the processes and functions of the disclosure, the sections below provide details and examples of arrangements for flexible channel access.

Some embodiments provide methods for enhancing spectrum efficiency by using a flexible and dynamic approach for channel allocation when LBT is used for channel access.

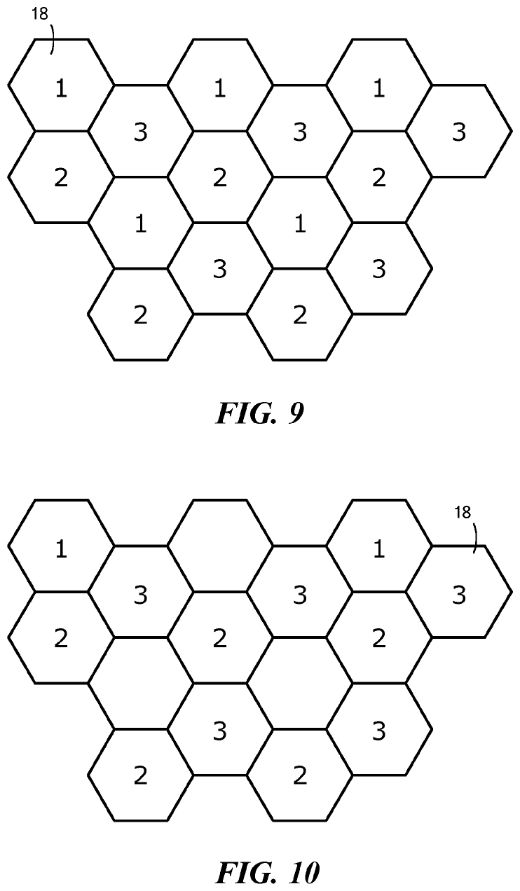

To illustrate the problem, consider a situation where the total band is shared by different network nodes 16 using frequency reuse 3. The principle for channel allocation for a set of neighboring network nodes 16 for frequency reuse 3 is depicted in FIG. 9. In FIG. 9, the respective number in the different cells 18 represent the channel that is used by that cell 18 (as provided by the corresponding network node 16). As is readily seen, two neighboring cells 18 do not use the same channel which ensures that the co-channel interference is somewhat under control although the carrier-to-interference-ratio (C/I) may not be e.g., more than 5 dB in unfavorable situations.

The limitation with a static frequency allocation becomes apparent when the loads in different cells 18 are very different. An illustrative example of this is shown in FIG. 10. In this example, none of the cells 18 in the center of the figure allocated to use channel 1 is active. Basically, this implies that channel 1 will be idle while the traffic demands on channels 2 and 3 may be very high. This is a momentaneous illustration of the channel usage, and at another moment in time, it may instead be so that channel 2 is unused in a large number of cells 18, while channel 1 is overloaded. However, the static channel allocation used in combination with frequency reuse is based on the assumption of an even load rather than the instantaneous fluctuations and thus a situation like the one illustrated in FIG. 10 may be expected to be quite common.

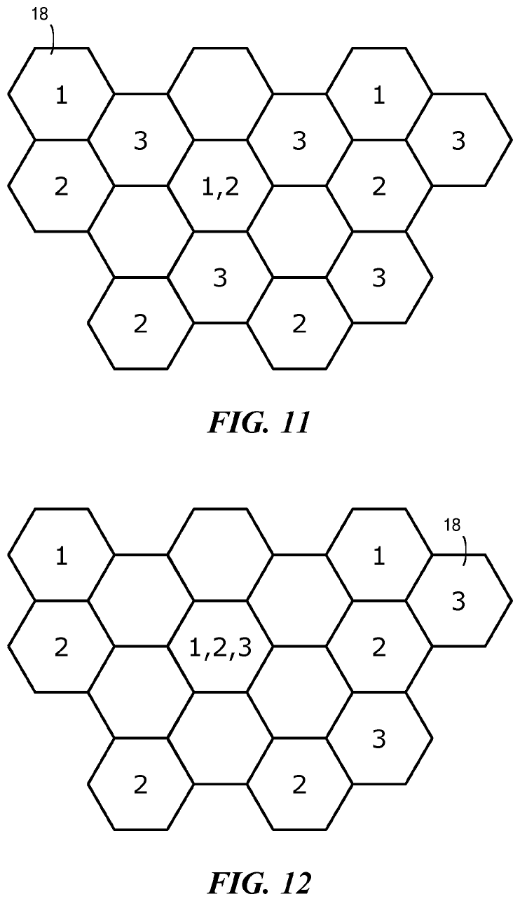

In some embodiments, a system is disclosed that uses frequency planning and in addition, LBT is used such that when a channel is determined to be unused, a cell 18 may use a frequency channel that according to the frequency planning is allocated to an adjacent cell 18. An example of this is shown in FIG. 11, where the cell 18 in the center which is allocated to use channel 2 is also using (part of) channel 1 as this is found to be unused.

In the example of FIG. 11, both channels 1 and 2 are used by the cell 18 in the center. However, it may be so that channel 1 is found to have better conditions than channel 2 (which is the one assigned according to the frequency reuse scheme). Then, the network node 16 may decide to use channel 1 instead of channel 2. Alternatively, the network node 16 may decide to use selected parts of channel 1 and selected parts of channel 2 based on similar considerations. These similar considerations may include the conditions of propagation channel being found to be superior for the selected parts. In case the cells 18 allocated to use channel 3 are idle, the cell 18 in the center would instead be able to use all three channels as illustrated in FIG. 12.

In FIGS. 9-12, only three channels were considered. This would be realistic if the operation would be in the 2.4 GHz Industrial, Scientific and Medical (ISM) band, where it is commonplace that Wi-Fi uses three non-overlapping 20 MHz channels and neighboring network nodes 16 typically try to avoid using the same channel. For operation in the 5 GHz or 6 GHz band, a larger set of channels are typically available, even when the channel bandwidth exceeds 20 MHz. However, if very wide channels are used, like 160 MHz, then employing three channels using frequency reuse would require sensing over 480 MHz, so in some cases a relatively small frequency reuse is not unrealistic. Having the ability to use a large bandwidth may also be very beneficial when the data rate is relatively small as will be discussed next.

First, suppose that both the network node 16 and all the WDs 22 support 160 MHz channels and that a frequency reuse of three is employed, as illustrated in FIG. 9. According to known methods, a device with data to send would perform LBT over a bandwidth that it intends to use in the upcoming transmission. If the channel is found idle, a transmission would take place, whereas if the channel is found to be busy the transmission would be deferred. It is possible, in principle, for a WD 22 that finds that only part of the channel is idle to adjust the bandwidth of the transmission or to puncture the transmission. Both these options come with their respective shortcomings, as discussed above. In particular, adjusting the bandwidth, for example, may be prohibitively complex to be used in practice.

In some embodiments disclosed herein, a different approach is taken to find a channel that is available for transmission, i.e., an idle channel. Many transmissions may not need very large bandwidth, so 20 MHz bandwidth for the transmission may be adequate in some applications. Using a large transmission bandwidth for lower data rates according to known methods may reduce the packet duration. However, this comes at a cost of increased probability of not finding an idle channel. In some embodiments, a packet is prepared for a relatively small bandwidth, e.g., 20 MHz, but then the LBT is performed over a bandwidth that exceeds this bandwidth. The LBT may for example, be performed over 80 MHz or 160 MHz. Taking 160 MHz as an example, the implication of this approach is that a transmission may be possible as long as at least one out of the eight 20 MHz channels is found to be idle.

Referring again to FIG. 9 and assuming that the three channels are 160 MHz wide each and that the different WDs 22 in the cells 18 only prepare packets for 20 MHz, but perform LBT over the full 160 MHz, this would result in a transmission within one cell 18, unless at least 8 other cells 18 within the same 160 MHz channel are active on disjoint 20 MHz channels and within range. Thus, the probability of channel access may be made very high with a very small, fixed frequency reuse.

At first, this may look very similar to having a system with a fixed frequency reuse of 24, using 20 MHz channels. There is a difference, however, in terms of flexibility. Suppose that a network node 16 within one of the cells 18 determines that at least 4 of the 8 20 MHz channels within the 160 MHz channel are idle every time LBT is performed. The network node 16 may then increase the bandwidth of the packet it prepares to, for example, 40 or even 80 MHz Then, the network node 16 may autonomously, i.e., without explicit coordination with the other network nodes 16 using the same 160 MHz channel, be able to adjust to a bandwidth that gives the best performance when it comes to data rate and probability of being able to find an idle channel of the selected bandwidth.

Moreover, different network nodes 16 within the same 160 MHz channel may select different bandwidths depending on their requirements. Specifically, a network node 16 where the average data rate is more important than delay requirements, may select a slightly larger bandwidth than a network node 16 for which the delay requirement is of more importance. Also, the very same network node 16 may select different bandwidths for different packets. For packets that are not delay sensitive, a larger bandwidth may be selected than for packet that are delay sensitive.

In a situation where the network node 16 supports several logical streams concurrently, e.g., one best effort and one voice stream, the network node 16 may then prepare two packets before doing the LBT with the intention to transmit both on different 20 MHz channels. It may that one 20 MHz packet carrying voice is prepared and another 20 MHz packet carrying best effort traffic is prepared. Upon doing the LBT, the network node 16 may follow one or more of the following steps:
If two or more 20 MHz channels are found idle, both packets are transmitted;
If only one 20 MHz channel is found idle, only the voice packet is sent. The voice packet is sent due to that it has higher latency requirements than the best effort packet; and/or If no 20 MHz channel is found, then no packet is sent.

If is also possible to prepare the best effort packet for a 40 MHz channel, for example and a voice packet for a 20 MHz channel. In that case, the corresponding decision based on the LBT outcome would may be one or more of the following:
If three or more 20 MHz channels are found idle, both packets are transmitted;
If two 20 MHz channels are found idle, the best effort packet are transmitted;
If only one 20 MHz channel is found idle, only the voice packet is sent; and/or
If not a single 20 MHz channel is found, then of course no packet is sent.

While it might seem with these rules that the best effort packet receives a higher priority this intuition is not correct, as the availability of two 20 MHz channels is less likely than the availability of a single 20 MHz channel.

In many cases more idle channels may be found than are actually needed. In case the packet is prepared for 40 MHz and the LBT is done over 160 MHz, it may be that 6 of the 20 MHz channels are found to be idle. In some embodiments, the selection of which one(s) of the available channels to use may therefore be based on the expected quality of the propagation channel. Specifically, the channel(s) where the least amount of interference is detected may be selected. As an example, suppose that the energy during the LBT process is estimated and as a result the power within the 8 20 MHz channels are found to be −90 dBm, −88 dBm, −86 dBm, −80 dBm, −80 dBm, −76 dBm, −70 dBm, and −65 dBm. Assuming that the LBT threshold is −72 dBm/20 MHz, this means that the first 6 channels are considered to be idle whereas the 2 last channels are found to be busy. Therefore, if the network node 16 has one voice packet which is 20 MHz and one best effort packet which is 40 MHz, there are a relatively large set of possible combinations for how to select between the 6 idle channels. In some embodiments, the network node 16 may select the first 3 channels with the lowest interference power. In addition, because it may be more important that the voice packet is delivered correctly without the need for a retransmission, the voice packet is preferably sent on the channel with the very best conditions, i.e., the channel with −90 dBm power.

The description above was based on starting with a frequency reuse of 3 and then effectively letting one third of the network nodes 16 share one 160 MHz channel in a flexible way, where 160 MHz corresponds to one third of the total bandwidth. This may be taken one step further by letting all network nodes 16 perform LBT over the full bandwidth and thus effectively letting even more network nodes 16 share a pool of even more channels. The performance may in this case be expected to improve, but there is a practical problem in that the involved devices performing LBT all need to be able to do this over a very large bandwidth.

In the examples above, it was assumed that both the network node 16 and the corresponding WDs 22 were able to operate over 160 MHz This assumption implies that in addition to performing the LBT over the larger bandwidth, the intended receiver is also capable of receiving over the wide bandwidth and thus may detect which one(s) of the 20 MHz channels have been selected by the transmitting device. It may be expected that the network node 16 may be able to perform LBT over a large bandwidth and it may also be assumed that the network node 16 will be in control of the channel access in a cell 18 such that it may schedule downlink as well as uplink transmissions. Therefore, the WDs 22 associated with a network node 16 may not have to perform LBT, at least not over a larger bandwidth than is intended to be used for the actual transmission. It may be expected that many WDs 22 may be low cost and low power devices without the ability to perform wideband LBT.

Now, consider the situation where the network node 16 performs LBT over a larger bandwidth than may be handled by the associated WDs 22. In this situation, the network node 16 may inform the WD 22 what channel(s) have been selected for transmission. In some embodiments, for narrowband WDs 22, this is done on a system level by using a dedicated control channel. As an example, suppose that a network node 16 is using 160 MHz which is divided into eight 20 MHz channels. One of these channels may be allocated to be a control channel, or an anchor channel to which all WDs 22 may listen when not actively involved in a data transmission. The anchor channel might only be used for a very short duration of time and just for signaling which one(s) of the other channels may be used for the actual data transmission, in some embodiments For example, suppose the network node 16 performs LBT on all eight channels. Suppose further without loss of generality that the first channel is the anchor channel. All network nodes 16 sharing the 160 MHz channel may agree on using the same channel as anchor channel.

Because the transmission is so short in time on the anchor channel, this channel may with very high probability be idle. The LBT on the remaining 7 channels are as described above, identifying which one(s) of the 20 MHz channels are used by other network nodes 16. Suppose that a network node 16, upon performing LBT, identifies channels 5,7, and 8 as idle and may be used for transmission, and that channel 5 is the one with the least amount of interference. The network node 16 may then send information on the anchor channel, i.e., channel 1, that channel 5 may be used for data. The WD(s) may receive the control information on the anchor channel and may thus know that they should switch to channel 5 for further instructions. The control information sent on channel 1 may or may not include information about what WDs 22 need to move to channel 5, or all WDs 22 may have to move to channel 5 and then the information about what WDs 22 may be involved in the communication may be signaled on channel 5. During the exchange of data on channel 5, neither the network node 16 nor the WDs 22 may use channel 1, which consequently may be used by another network node 16 for signal control information in a similar way.

An alternative to support narrow-band WDs 22 associated to a dynamic spectrum network node 16 is to use a primary channel. In contrast to the described anchor channel the primary channel is a narrow-band (20 MHz) channel that is different for all cells 18, or is reused only within a large distance. The network node 16 may still perform LBT on a wide bandwidth, but all WDs 22 are “parked” on the primary channel. Once the network node 16 has finished the LBT, and has determined on which 20 MHz channels to transmit, it initializes the transmission opportunity by sending a channel announcement and reservation packet on all identified channels. This channel set may include the primary channel. Upon reception by the “parked” WDs 22, they may receive the information on which channels they are going to receive their data; thus, they may tune their receiver to the appropriate frequency. Other neighboring WDs 22 tuned to different channels may receive the packet as well and may thus identify the channels as busy.

Information sharing between transmitter and intended receiver(s) to select subset of idle channels for communication.

In some embodiments, the selection of an appropriate subset of channels among the idle channels is based on information sharing between the transmitter and the intended receiver(s).

This has an advantage that the transmissions may be undertaken by also taking into account the channel conditions at the intended receiver(s).

### a) Information Sharing Using RTS-CTS Frame Exchange

IEEE 802.11 supports an optional frame exchange mechanism involving request-to-send (RTS) and clear-to-send (CTS) control frames. In the most basic form of this RTS-CTS frame exchange, a transmitter first transmits a RTS frame to reserve the channel and also to indicate to an intended receiver its intention to transmit over a particular communication bandwidth. This is followed by the intended receiver responding or not responding with a CTS frame depending on whether it senses that particular communication bandwidth to be idle or busy respectively.

Correspondingly, in some embodiments, the transmitter indicates in the RTS frame to an intended receiver not only its intended communication bandwidth but also the channels it has sensed idle, which may be cumulatively wider than the intended communication bandwidth. Then, for example, if the intended receiver is capable of performing similar wideband LBT, it may convey some useful information to the transmitter via the CTS frame. Such information may include information about the channel quality of different idle channels (e.g., in terms of energy estimated during LBT), and/or the interference conditions observed in the different channels, and/or the subset of channels preferred by the intended receiver for reception, etc. Upon receiving such information, the transmitter may take appropriate decisions regarding the selection of subset of channels for transmission.

### b) Information Sharing Using Trigger Frame

IEEE 802.11 supports triggered uplink transmissions, wherein a network node 16 may trigger specific WDs 22 for uplink transmission and may also select corresponding transmission parameters such as transmission powers, modulation and coding schemes for these uplink transmissions. Examples of such trigger based uplink transmissions are multi-user uplink orthogonal frequency division multiple access (OFDMA) transmissions introduced in IEEE 802.11ax or single-user trigger-based uplink transmissions introduced in IEEE 802.11be.

Correspondingly, some embodiments, while triggering an uplink transmission, a network node 16 may provide information to a triggered WD 22 regarding the different channels it has sensed idle, and/or the channel quality of the idle cannels (e.g., in terms of energy estimated during LBT), and/or the subset of channels preferred by the network node 16 for reception, etc. Upon receiving such information, the WD 22 may take appropriate decisions regarding the selection of subset of channels for uplink transmission.

### c) Information Sharing Using Dedicated Control Channel or Anchor Channel

Usage of a dedicated ‘control channel’ or ‘anchor channel’ or primary channel’ is described above for the cases wherein a network node 16 is capable of performing LBT over a larger bandwidth than may be handled by the associated WDs 22.

Correspondingly, in some embodiments, sharing of information between a transmitter and intended receiver(s) may enable appropriate selection of a subset of channels for transmission over the dedicated control/anchor/primary channel.

Some embodiments may include one or more of the following:
1. A method of channel access in a system using LBT, characterized in that the LBT is performed over a bandwidth which exceeds the maximum bandwidth over which the corresponding transmission is intended for;
2. The method of Embodiment 1, where the bandwidth is divided into channels and where the LBT is performed over a number of channels that is strictly larger than the maximum number of channels that may be used for the corresponding transmission.
3. The method of Embodiment 2, where the channel bandwidth is 20 MHz
4. The method of any of Embodiments 1-3, where the channels selected for transmission are the ones which are determined to provide the most favorable conditions.
5. The method of any of Embodiments 1-4, where the channel conditions are based on the estimated interference and where the most favorable channel conditions correspond to that the estimated interference power is lower for these channels.
6. The method of Embodiments 4 and 5, where the selection of channels for transmission is based on information sharing between a transmitter and intended receiver(s).
7. The method of any of Embodiments 1-6, where in addition the transmission is intended to carry information of different latency requirements and where the packet carrying information with stricter latency requirements is sent in case it is not possible to send all packets due to that too few channels are found to be idle.
8. The method of any of Embodiments 1-7, where the transmitter performing LBT selects the bandwidth to be used in the transmission at least in part on the load of the system such that a smaller bandwidth is selected when the load of the system is determined to be higher.
9. The method of Embodiment 8, where the bandwidth used in the transmission is a function of the bandwidth found to be idle and the load of the system such that a larger bandwidth is used for the transmission if a larger bandwidth is found to be idle (for the same load).
10. The method of any of Embodiments 1-9, where the intended receiver is not able to receive a signal of a bandwidth equal to the LBT bandwidth and therefore need to obtain explicit information from the transmitter on a dedicated channel to know which part of the LBT bandwidth has been selected by the transmitter to be used for communication.
11. The method of Embodiment 10, where the dedicated channel is a narrowband channel which is used by two or more network nodes 16 that are both using the same LBT bandwidth.
12. The method of Embodiment 11, where the bandwidth of the dedicated channel is 20 MHz

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AP Access Point
BSS Basic Service Set
BO Back-Off
COOFDMA Coordinated OFDMA
DCF Distributed Coordination Function
CW Contention Window
DL Downlink
LBT Listen Before Talk
MBB Mobile Broad Band
MIMO Multiple Input Multiple Output
OFDM Orthogonal Frequency Division Multiplexing
OFDMA Orthogonal Frequency Division Multiple Access
RA Random Access
STA Station
TXOP Transmit Opportunity
UL Uplink
UE User Equipment
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a WD configured to communicate with a network node the method comprising:
performing a wideband listen-before-talk, LBT, process over a wideband LBT bandwidth, the wideband LBT bandwidth being wider than a maximum channel bandwidth intended for a transmission, the wideband LBT bandwidth including a plurality of channels and the wideband LBT process being performed over N channels of the plurality of channels, N being an integer greater than a maximum number of channels included in the maximum channel bandwidth intended for the transmission;
determining a presence of at least one idle channel based at least in part on the wideband LBT process; and
selecting an idle channel determined to be present for the transmission based at least in part on channel conditions of the idle channel.

2. (canceled)

3. (canceled)

4. The method of claim 1, wherein the channel conditions of the idle channel include an estimated interference power of the idle channel.

5. The method of claim 1, further comprising:
receiving channel selection information and selecting an idle channel for the transmission based at least in part on the channel selection information; and
transmitting channel feedback information to the network node, the channel feedback information being based at least in part on channel conditions at the WD.

6. (canceled)

7. The method of claim 1, further comprising selecting a packet to be transmitted on an idle channel based at least in part on a latency requirement of the packet and a number of idle channels determined to be present.

8. The method of claim 1, further comprising:
selecting a transmission channel bandwidth for the transmission based at least in part on a bandwidth of channels determined to be idle;
wherein selecting the transmission channel bandwidth for the transmission includes selecting a different channel bandwidth for each of a plurality of packets to be transmitted; and
wherein the transmission channel bandwidth selected for a packet transmission depends at least in part on a latency requirement.

9. (canceled)

10. (canceled)

11. A WD configured to communicate with a network node, the WD comprising processing circuitry configured to:
perform a wideband listen-before-talk, LBT, process over a wideband LBT bandwidth, the wideband LBT bandwidth being wider than a maximum channel bandwidth intended for a transmission, the wideband LBT bandwidth including a plurality of channels and the wideband LBT process being performed over N channels of the plurality of channels, N being an integer greater than a maximum number of channels included in the maximum channel bandwidth intended for the transmission;
determine a presence of at least one idle channel based at least in part on the wideband LBT process; and
select an idle channel determined to be present for the transmission based at least in part on channel conditions of the idle channel.

12. (canceled)

13. (canceled)

14. The WD of claim 11, wherein the channel conditions of the idle channel include an estimated interference power of the idle channel.

15. The WD of claim 11, further comprising a radio interface in communication with the processing circuitry and configured to receive channel selection information and selecting an idle channel for the transmission based at least in part on the channel selection information, wherein the radio interface is further configured to transmit channel feedback information to the network node, the channel feedback information being based at least in part on channel conditions at the WD.

16. (canceled)

17. The WD of claim 11, wherein the processing circuitry is further configured to select a packet to be transmitted on an idle channel based at least in part on a latency requirement of the packet and a number of idle channels determined to be present.

18. The WD of claim 11, wherein the processing circuitry is further configured to:
select a transmission channel bandwidth for the transmission based at least in part on a bandwidth of channels determined to be idle;
wherein selecting the transmission channel bandwidth for the transmission includes selecting a different channel bandwidth for each of a plurality of packets to be transmitted; and
wherein the transmission channel bandwidth selected for a packet transmissions depends at least in part on a latency requirement.

19. (canceled)

20. (canceled)

21. A method in a network node configured to communicate with a wireless device, WD the method comprising:
performing a wideband listen-before-talk, LBT, process over a wideband LBT bandwidth, the wideband LBT bandwidth being wider than a maximum channel bandwidth intended for a transmission, the wideband LBT bandwidth including a plurality of channels and the wideband LBT process being performed over N channels of the plurality of channels, N being an integer greater than a maximum number of channels included in the maximum channel bandwidth intended for the transmission;
determining a presence of at least one idle channel based at least in part on the wideband LBT process; and
selecting an idle channel determined to be present for the transmission based at least in part on channel conditions of the idle channel.

22. (canceled)

23. The method of claim 21, wherein the channel conditions of the idle channel include an estimated interference power of the idle channel.

24. The method of claim 21, further comprising transmitting to the WD on a dedicated channel an indication of a portion of an idle channel to be used for the transmission; and
receiving channel feedback information from the WD, the channel feedback information being based at least in part on channel conditions at the WD, and determining the portion of the idle channel based at least in part on the channel feedback information;
wherein the dedicated channel is a narrowband channel used by at least one other network node that uses the wideband LBT bandwidth.

25. (canceled)

26. (canceled)

27. The method of claim 21, further comprising selecting a packet to be transmitted on an idle channel based at least in part on a latency requirement of the packet and a number of idle channels determined to be present.

28. The method of claim 21, further comprising selecting a channel bandwidth for the transmission based at least in part on a traffic load, selected channel bandwidth being inversely proportional to the traffic load.

29. The method of claim 21, further comprising:
selecting a transmission channel bandwidth for the transmission based at least in part on a bandwidth of channels determined to be idle;
wherein selecting the transmission channel bandwidth for the transmission includes selecting a different channel bandwidth for each of a plurality of packets to be transmitted; and
wherein the transmission channel bandwidth selected for a packet transmissions depends at least in part on a latency requirement.

30. (canceled)

31. (canceled)

32. A network node configured to communicate with a wireless device, WD the network node comprising processing circuitry configured to:
perform a wideband listen-before-talk, LBT, process over a wideband LBT bandwidth, the wideband LBT bandwidth being wider than a maximum channel bandwidth intended for a transmission, the wideband LBT bandwidth includes a plurality of channels and the wideband LBT process is performed over N channels of the plurality of channels, N being an integer greater than a maximum number of channels included in the maximum channel bandwidth intended for the transmission;
determine a presence of at least one idle channel based at least in part on the wideband LBT process; and
select an idle channel determined to be present for the transmission based at least in part on channel conditions of the idle channel.

33. (canceled)

34. The network node of claim 32, wherein the channel conditions of the idle channel include an estimated interference power of the idle channel.

35. The network node of claim 32, further comprising a radio interface in communication with the processing circuitry and configured to transmit to the WD on a dedicated channel an indication of a portion of an idle channel to be used for the transmission, wherein the radio interface is further configured to receive channel feedback information from the WD, the channel feedback information being based at least in part on channel conditions at the WD, and determine the portion of the idle channel based at least in part on the channel feedback information.

36. (canceled)

37. (canceled)

38. The network node of claim 32, wherein the processing circuitry is further configured to select a packet to be transmitted on an idle channel based at least in part on a latency requirement of the packet and a number of idle channels determined to be present.

39. The network node of claim 32, wherein the processing circuitry is further configured to select a channel bandwidth for the transmission based at least in part on a traffic load, selected channel bandwidth being inversely proportional to the traffic load.

40. The network node of claim 32, wherein the processing circuitry is further configured to:
select a transmission channel bandwidth for the transmission based at least in part on a bandwidth of channels determined to be idle;
wherein selecting the transmission channel bandwidth for the transmission includes selecting a different channel bandwidth for each of a plurality of packets to be transmitted; and
wherein the transmission channel bandwidth selected for a packet transmissions depends at least in part on a latency requirement.

41. (canceled)

42. (canceled)
